(19) United States
(12) Patent Application Publication
(10) Pub. No.: US 2010/0253008 A1
(43) Pub. Date: Oct. 7, 2010

(54) Sealing arrangement

(76) Inventor: Wojtek Kolasinski, Nurtingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/457,655

(22) Filed: Jun. 17, 2009

(30) Foreign Application Priority Data
Jun. 20, 2008 (DE) 10 2008 029 444.6

(51) Int. Cl. F02F 11/00; F16J 15/06; F16L 25/00

(52) U.S. Cl. 277/591; 277/608

(57) ABSTRACT

A sealing arrangement for sealing of connecting sites (5) on flow paths (7) for flowable media, in particular for hot gases such as exhaust gases of internal combustion engines, with a sealing body (19) which adjoins the sealing surfaces (15, 17) of the connection sites (5) under a sealing force, is characterized in that a control body (25) is assigned to the sealing body (19) and is mechanically and thermally coupled to the sealing body (19) and to the surface regions (1, 3) on the connection sites (5) of the flow path (7) and transfers the sealing body (19) under thermal load into a state which produces an increased sealing force.

The invention relates to a sealing arrangement for sealing of connection sites on flow paths for flowable media, in particular for hot gases such as exhaust gases of internal combustion engines, with a sealing body which adjoins the sealing surfaces of the connection sites under a sealing force.

Advances in technology in the area of internal combustion engines, in particular with respect to optimization of consumption and improved performance, are leading to rising temperatures in the exhaust gas region and thus to rising demands for stability of sealing connections at the transition between the cylinder head and exhaust gas manifold, exhaust gas manifold and exhaust gas turbocharger, exhaust gas manifold and catalytic converter or turbocharger and exhaust pipe. In spite of using metallic sealing bodies of high quality, heat-resistant material alloys, known sealing arrangements under high thermal stresses often do not meet requirements with respect to sufficient service life.

With respect to this problem, the object of the invention is to make available a sealing arrangement which for connection sites on flow paths for hot gases ensures reliable sealing over long operating times, even under conditions under which special thermal stresses arise.

This object is achieved according to the invention by a sealing arrangement which has the features of claim 1 in its entirety.

According to the characterizing part of claim 1, the essential feature of the invention consists in that the sealing body is influenced not only and not exclusively by the thermal and mechanical loads which occur, but that a control element is assigned to the sealing body and, acting as an additional auxiliary or support means, influences the sealing body under thermal load such that an increased sealing force is produced on the sealing surfaces.

The control body can be effective in different ways. For example, a suitable choice of the coefficients of thermal expansion can result in that with thermal expansion of the overall combination of flange parts of the connection sites, of the sealing body and of the control body, different rates of expansion can lead to formation of forces which act between the sealing body and the control body, specifically to auxiliary forces which increase the sealing force, or to support forces which prevent deformations of the sealing body.

For especially advantageous embodiments, the sealing body is formed by an annular body with annular jacket regions which have different radial distances from the axis of the annular body, a flat annular jacket region which lies farthest radially outside or farthest radially inside on the annular body forming at least one sealing region for the contact with the sealing surfaces which is effected with a radial sealing force, which sealing surfaces are made flush with one another and concentric to the axis of the flow path at the connection sites.

The sealing arrangement here advantageously forms a radial seal, there being better thermal decoupling of the radially end-side sealing region of the annular body based on the radial distance which is present between the assigned sealing surfaces on flange parts of the connection site and the immediate hot zones on the flow path, compared to axial seals for which conventionally beaded or unbeaded flat seals are much more thermally stressed by almost directly adjoining the flange parts surrounding the flow path.

The control body can be formed by an inner ring that adjoins the annular body which forms the sealing body for supporting the annular body against forces in the radial direction on the contact surfaces of the annular body.

The inner ring can be a simple solid ring without profiling.

For especially advantageous embodiments the inner ring is a metallic profile ring with lateral outside peripheral surfaces which form outside circular ring surfaces which are located in the planes perpendicular to the ring axis. In such a configuration of the inner ring, it can also adjoin other contact surfaces of the annular body with its outer circular ring surfaces for the transmission of forces which act not only in the radial direction, but also in the axial direction. In this way, in addition to an auxiliary force which increases the radial sealing force, an additional axial auxiliary force can also be transferred to the sealing body.

In an especially advantageous manner the arrangement can be such that the inner ring has a profile which is U-shaped in cross section and which has a profile crosspiece which connects the lateral, axially outer circular ring surfaces, whose outside forms the circularly cylindrical contact surface which is concentric to the ring axis for the support of the annular body against radial forces.

In especially advantageous embodiments the annular body which forms the sealing body is made as a profile ring whose central annular jacket region which lies radially farthest to the outside is adjoined on both sides by lateral profile leg parts which bent or angled extend radially to the inside against the inner ring which forms the control body and form the contact surfaces for it. In this configuration of the sealing body as a beaded annular body, interaction takes place with the sealing surfaces at the connection site not over the entire axial extension of the annular body, but only on the annular jacket region which lies radially farthest to the outside so that the compressive load per unit of area which is produced by the sealing force is increased as a result of the reduced contact area.

Preferably the profile leg parts have a flat configuration.

For advantageous embodiments the annular body is designed such that the profiled leg parts are adjoined by angled end sections which likewise run flat. They can form concentric contact surfaces for the contact surface with the profile crosspiece of the inner ring.

The annular body which forms the sealing body can be provided with a peripheral foot part, specifically such that the profile leg parts or their end sections are adjoined by an outside foot part which forms the circular ring surfaces of the annular body and which on the inside forms a contact surface for the outer circular ring-shaped contact surface. The annular body which forms the sealing body is therefore supported on the inner ring not only against radial forces, but also forms an enclosure for the inner body which is held within the annular space of the annular body, i.e., the annular body and inner body form a combination in which both bodies are mutually supported against radial forces and axial forces. This support can be optimized by a solid bead which increases the axial thickness of the annular body being configured on one of the circular ring surfaces.

In especially advantageous embodiments the arrangement is made such that the annular body and inner ring are held in annular grooves which are formed at the connection sites of the flow path, for example, in flange parts which adjoin one another at the connection sites. The depth of the annular grooves and the axial dimension of the sealing body here can be chosen such that the bottom surfaces of the annular grooves prevent axial creep of the annular body under load, that therefore flattening of the profiled legs which determine the bead height cannot take place.

For applications in which the sealing arrangement is exposed to especially high thermal stresses, the arrangement can be advantageously made such that the inner ring which forms the control body is made in several layers and has at least one layer of heat insulating material which is radially nearest the flow path and another metallic layer as the actual control element.

The invention is explained in detail below using embodiments shown in the drawings.

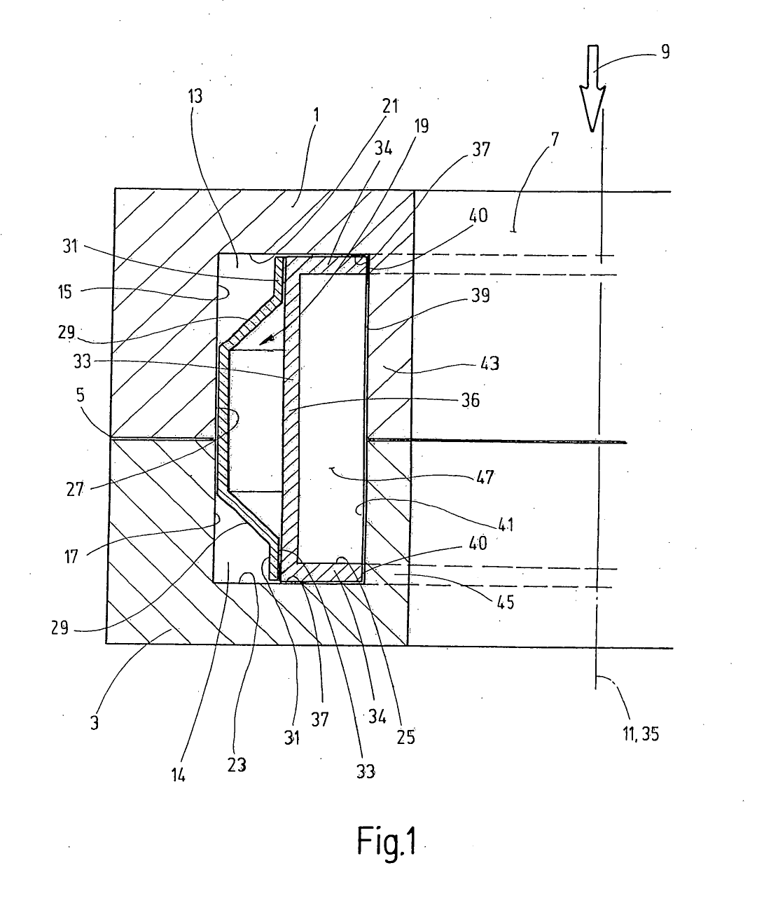

FIG. 1 shows a schematically simplified, half-side partial longitudinal section of the connection site of an exhaust gas flow path which is shown greatly enlarged relative to a practical embodiment, details and dimensioning of parts of the sealing arrangement being shown partially exaggerated for illustration of the operating principle, and

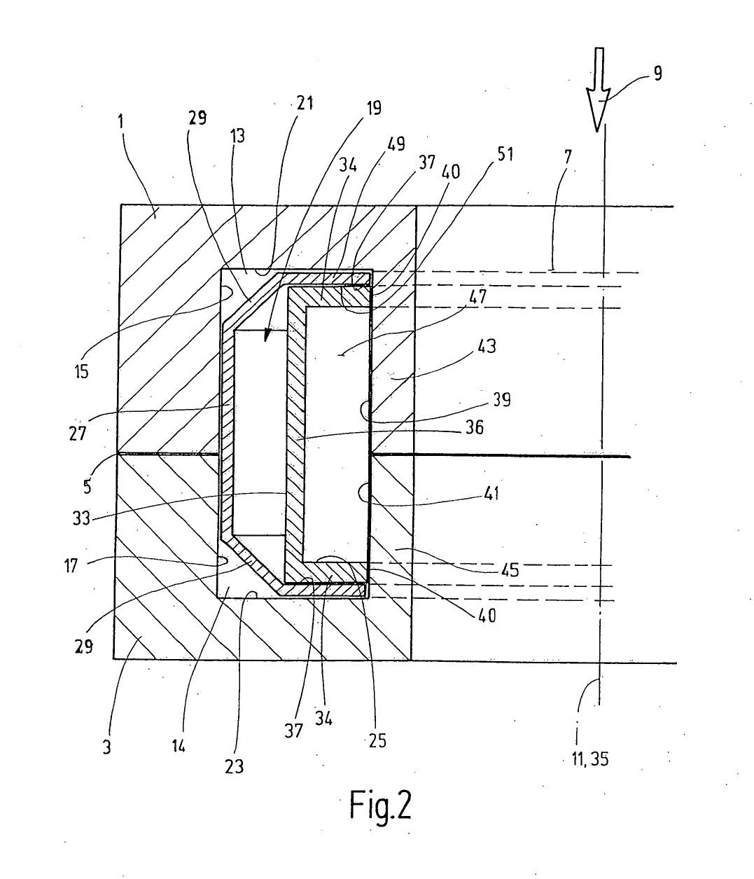

FIGS. 2 to 6 show representations similar to FIG. 1 of five other embodiments of the sealing arrangement.

In the drawings flange parts are designated as 1 and 3; they adjoin one another at a connection site 5 of a flow path 7 through which a gas flows along its longitudinal axis 11, as indicated with a flow arrow 9.

The flange parts 1 and 3 as the seat for the sealing arrangement each have an annular groove 13 which is open at the connection site 5, whose radially external walls 15 and 17 form annular surfaces which are concentric to the axis 11 of the flow path 7 and which are flush with one another, and which, interacting with the main sealing region of an annular body 19 which is used as the sealing body and which is designated as a whole as 19, form a radial seal at the connection site 5. The depth of the annular grooves 13, 14 is chosen such that when the flange parts 1 and 3 adjoin one another, the distance between the bottom surfaces 21 and 23 of the annular grooves corresponds to the axial width of the annular body 19 so that the installed annular body 19 is supported by support on the bottom surfaces 21, 23 under loading with radial forces against axial creep.

The control body which influences the operating behavior of the sealing body is an inner ring 25 which, in the examples shown in FIGS. 1 to 3, has the shape of a metallic profile ring, more precisely, a profile which is U-shaped in cross section, short side legs 34 being connected by a longer profile crosspiece 36. Its outside forms a circularly cylindrical contact surface 33 which is concentric to the ring axis 35 and on which the annular body 19 is supported against radial forces. The lateral, outer peripheral surfaces of the legs 34 of the inner ring 25 form outer circular ring surfaces 37 which lie in the planes that are perpendicular to the ring axis 35.

The annular body 19 which is used as the sealing body is likewise made as a beaded profile ring, a central, flat annular jacket region 27 which lies radially farthest outside forming a radial seal on the sealing surfaces which are formed by the side walls 15 and 17 of the annular grooves 13, 14. This elevated annular jacket region 27 is connected on both sides to bent profile leg parts 29 which extend obliquely against the inner ring 25. In the embodiment shown in FIG. 1, the profile leg parts 29 are adjoined by flat end parts 31 which extend as far as to the axial end edge of the annular body 19 and form a contact surface which is concentric to the annular body axis 35 which corresponds to the axis 11 of the flow path 7 for support on the contact surface 33 of the inner ring 25. In the embodiment of FIG. 1 the axial width of the inner ring 25 corresponds to the total depth of the annular grooves 13, 14 so that the bottom surfaces 21, 23 of the annular grooves 13, 14 form a contact surface for the outer ring surfaces 37 of the inner body 25. The latter is supported on its radially inner side edges 40 on the insides 39, 41 of the radially inner walls 43, 45 of the annular grooves 13, 14.

According to the thickness of the walls 43, 45, there is thermal decoupling of the sealing arrangement from the annular body 19 and the inner ring 25 relative to the flow path 7. Under thermal load, by a selected rate of thermal expansion of the inner ring 25 in the direction perpendicular to its axis, compared to the expansion of the overall combination, an auxiliary force can be produced which is directed at the annular body 19 in the radial direction (relative to the axis 11, 35) and which on the annular jacket region 27 acts as an additional sealing force on the side surfaces 15 and 17 which are used as the sealing surface. Here, pressing the beading of the annular body 19 flat, i.e., axial creep of the annular body 19, is prevented by the support on the bottom surfaces 21 and 23 of the annular grooves 13, 14. A gas pressure which builds up in the interior 47 of the sealing arrangement in operation contributes to a further increase of the sealing force. It goes without saying that the walls 43, 45 could be shortened and would not have to be made abutting the connection site 5.

The embodiment of FIG. 2 differs of FIG. 1 in that the profile leg parts 29 which are angled away from the central annular jacket region 27 of the annular body 19 extend as far as to the bottom surfaces 21, 23 of the annular grooves and undergo transition there into a foot part 49 which forms circular ring surfaces and which lengthens the annular body 19 in the radial direction. The inner circular ring surface of the foot part 49 forms a contact surface 51 for the outer ring surface 37 of the inner ring 25.

In this embodiment, by means of the inner ring 25 under thermal load, not only can an auxiliary force be produced which acts radially on the annular body 19, but by way of the contact surface 51 with the foot part 49 also an axial auxiliary force can be produced which presses the foot part 49 against the bottom surfaces 21, 23, forming a seal.

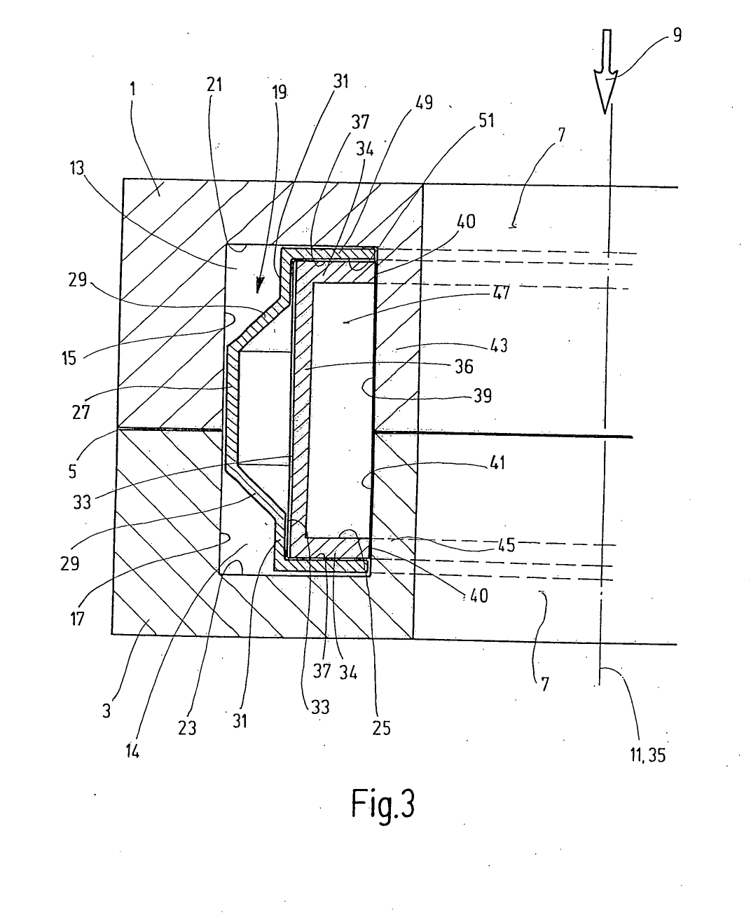

In the example shown in FIG. 3, the annular body 19 is likewise radially lengthened by a foot part 49 to which an axial auxiliary force can be transferred from the inner ring 25. Unlike the example of FIG. 2, the foot part 49 is not directly continuous with the profile leg parts 29 which are bent obliquely, but they are, as in the example of FIG. 1, lengthened by the axially extending end parts 31, whose ends in turn pass into the foot part 49 which is bent at a right angle. In this embodiment, as in the example of FIG. 1, there is comparatively extensive area contact between the contact surface 33 on the crosspiece 36 of the inner ring 25 and the flat end parts 31 of the annular body 19. At the same time, besides a radial auxiliary force, an axial auxiliary force can also be transferred to the annular body 19 by the control body for the inner ring 25 which acts as the sealing body so that a sealing force can also be produced between the foot part 49 and the bottom surfaces 21, 23 of the annular grooves 13, 14.

The invention is explained above using examples in which the inner ring 25 has the shape of a profile ring with a U-shaped cross section. It goes without saying that other designs are possible. What is essential is simply that the inner ring interacts with the annular body 19 which acts as the sealing body such that thermal loads on the combination lead to an increased sealing force which acts on the annular body 19. Instead of a U-profile ring, there could also be a solid ring. There could also be a ring with filling of a filling material which has certain thermal properties, which filling is located in a closed annular chamber, for example, in the form of a gel of a porous or particulate filler material.

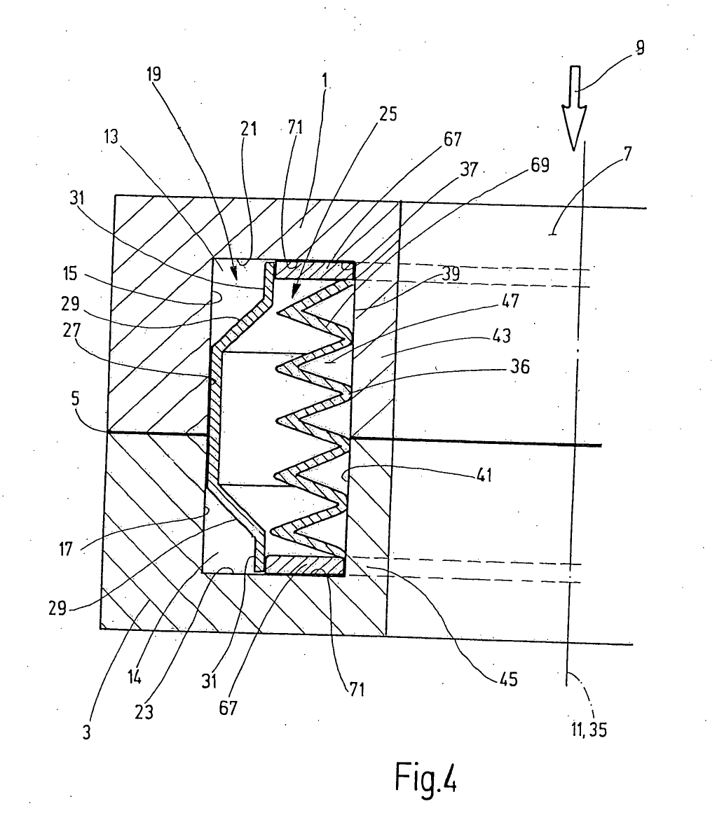

The inner ring can also be made in several parts, as is the case in the other embodiment shown in FIG. 4. The inner ring 25 interacts in this connection with an annular body 19 of the same design made as a sealing body, as is also the case in FIG. 1. The annular body 25 is, however, formed from two circular ring-shaped disks 67 which form the two axial ends and which are connected to one another by way of a metal bellows 69 which forms the peripheral jacket body of the inner ring 25. The gas pressure which builds up in operation in space 47 acts by way of the expansion of the bellows 69 as an additional sealing force, specifically by pressing the outside 71 of the ring disks 67 against the respective bottom 21 and 23 of the annular groove 13 and 14, while, as in the embodiment of FIG. 1, a radial force is transmitted by way of the ends of the ring disks 67 to the end parts 31 of the annular body 19 in order to increase the radial sealing force with which the annular jacket region 27 is pressed against the sealing surfaces 15, 17.

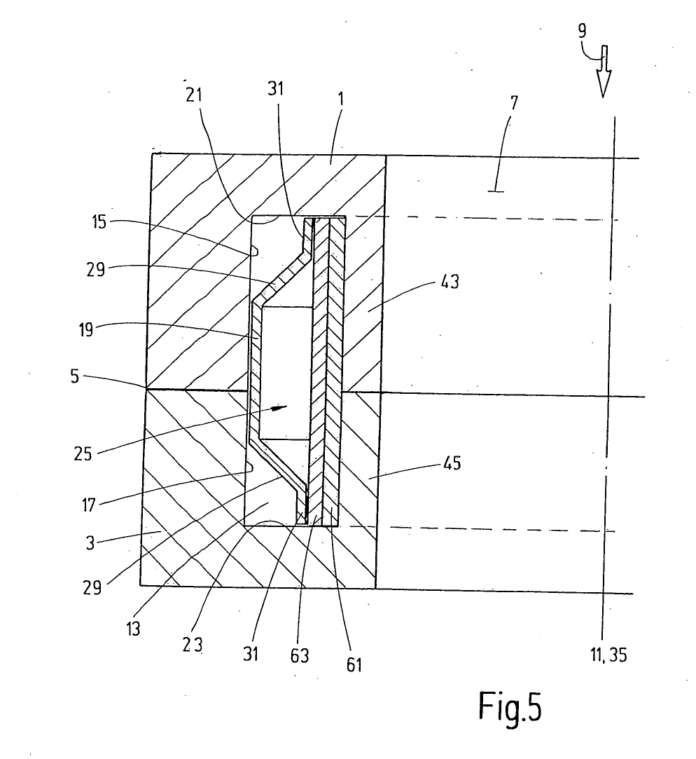

FIG. 5 illustrates another example with an inner ring 25 which is made of several layers and which interacts with an annular body 19 of the same design which acts as the sealing body, as is the case in FIG. 1. The annular body 25 is, however, formed from two layers 61 and 63 which form two flat rings at a time and which are radially laminated, the layer 61 which is radially nearest the flow path 7 being formed from heat-insulating material such as from mica, ceramic or glass wool. The layer 63 which adjoins radially outside is a metal layer which forms the actual control element for the interaction with the sealing body (annular body 19).

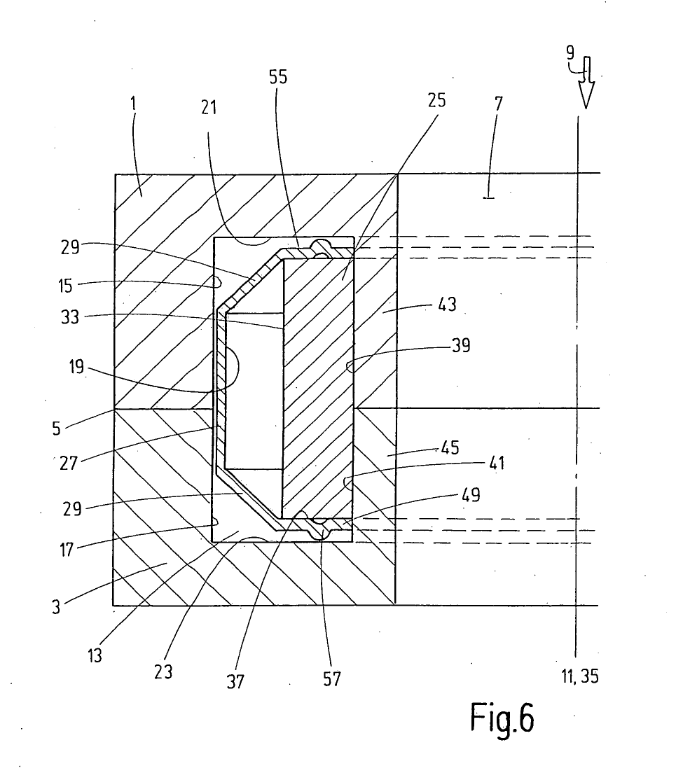

The other embodiment shown in FIG. 6 is made analogously to the embodiment of FIG. 2. In contrast, however, the inner ring 25 is not made as a profile ring, but is a solid ring with a rectangular wall cross section. As in the embodiment of FIG. 2, the outer surface 37 of the inner ring 25 is overlapped by the foot part 49 of the annular body 19. In the example of FIG. 6, however, the outer circular ring surface 55 of the foot part 49 does not adjoin the bottom surfaces 21 and 23 flat, but in the foot part 49 a solid bead 57 which projects axially to the outside is formed, by way of which a compressive axial auxiliary force is produced which acts to seal between the foot part 49 and the bottom surfaces 21, 23. The bead force of the solid bead 57 can be set in a controlled manner by dimensioning. In addition, an additive bead force which acts as an axial sealing force is produced by thermal expansion.

In the embodiments shown here the sealing element is located on the side of the control body which is radially distant from the flow path 7. It goes without saying that the sealing element 19 could also adjoin the radially inside groove inner surface.

1. A sealing arrangement for sealing of connecting sites (5) on flow paths (7) for flowable media, in particular for hot gases such as exhaust gases of internal combustion engines, with a sealing body (19) which adjoins the sealing surfaces (15, 17) of the connection sites (5) under a sealing force, characterized in that a control body (25) is assigned to the sealing body (19) which is mechanically and thermally coupled to the sealing body (19) and to the surface regions (1, 3) on the connection sites (5) of the flow path (7) and transfers the sealing body (19) under thermal load into a state which produces an increased sealing force.

2. The sealing arrangement according to claim 1, characterized in that the sealing body is an annular body (19) with annular jacket regions which have different radial distances from the axis (35) of the annular body, a flat annular jacket region (27) which lies farthest radially outside forming at least one sealing region for the contact with the sealing surfaces (15, 17) which takes place with a radial sealing force, which sealing surfaces are made flush with one another and concentric to the axis (11) of the flow path (7) at the connection sites (5).

3. The sealing arrangement according to claim 1 or 2, characterized in that the control body is formed by an inner ring (25) which adjoins the annular body (19) for supporting the latter against forces in the radial direction on the contact surfaces (33) of the annular body (19).

4. The sealing arrangement according to claim 3, characterized in that the inner ring (25) is a solid ring.

5. The sealing arrangement according to claim 3, characterized in that the inner ring (25) is a metallic profile ring with lateral outside peripheral surfaces which form outside circular ring surfaces (37) which are located in the planes perpendicular to the ring axis (35).

6. The sealing arrangement according to claim 4 or 5, characterized in that the inner ring (25) with its outer circular ring surfaces (37) also adjoins other contact surfaces (51) of the annular body (19) for the transmission of forces which act in the axial direction.

7. The sealing arrangement according to claim 5 or 6, characterized in that the inner ring (25) has a profile which is U-shaped in cross section and which has a profile crosspiece (36) which connects the lateral, axially outer circular ring surfaces (37), whose outside forms the circularly cylindrical contact surface (33) which is concentric to the ring axis (35) for the support of the annular body (19) against radial forces.

8. The sealing arrangement according to one of claims 5 to 7, characterized in that the annular body (19) which forms the sealing body is made as a profile ring whose central annular jacket region (27) which lies radially farthest to the outside is adjoined on both sides by lateral profile leg parts (29) which bent or angled extend radially to the inside against the inner ring (25) which forms the control body and form the contact surfaces for it.

9. The sealing arrangement according to claim 8, characterized in that the profile leg parts (29) run flat.

10. The sealing arrangement according to claim 8 or 9, characterized in that the profiled leg parts (29) are adjoined by angled end sections (31) which likewise run flat.

11. The sealing arrangement according to claim 10, characterized in that the end sections (31) form concentric contact surfaces for the contact surface (33) with the profile crosspiece (36) of the inner ring (25).

12. The sealing arrangement according to one of claims 7 to 10, characterized in that the profile leg parts (29) or their end sections (31) are adjoined by an outside foot part (49) which forms the circular ring surfaces of the annular body (19) and which on the inside forms a contact surface (51) for the outer circular ring-shaped contact surface (37) of the inner ring (25).

13. The sealing arrangement according to claim 12, characterized in that an axially projecting solid bead (57) is formed on the axially outside circular ring surface (55) of the foot part (49).

14. The sealing arrangement according to one of claims 1 to 13, characterized in that the annular body (19) which forms the sealing body and the inner ring (25) which forms the control body are held chambered in annular grooves (13, 14) which are made at the connection sites (5) of the flow path (7), in particular are machined into adjoining flange parts (1, 3).

15. The sealing arrangement according to claim 14, characterized in that the side surfaces (15, 17) of the annular grooves (13, 14), which surfaces lie radially outside relative to the axis (11) of the flow path (7), form concentric sealing surfaces which are flush with one another for the sealing region (27) of the annular body (19), which region adjoins with a radial sealing force.

16. The sealing arrangement according to claim 14 or 15, characterized in that the bottom surfaces (21, 23) of the annular grooves (13, 14), which surfaces are perpendicular to the axis (11) of the flow path (4), form support surfaces for the outer ring-shaped surface (37) of the inner ring (25) or the foot part (49) of the annular body (19) which forms the sealing body, which foot part overlaps the inner ring.

17. The sealing arrangement according to one of claims 3 to 16, characterized in that the inner ring (25) which forms the control body is made in several layers and has at least one layer (61) of heat insulating material which is radially nearest the flow path (7) and another metallic layer (63) as the actual control element.
